(19) United States
(12) Patent Application Publication
(10) Pub. No.: US 2018/0305254 A1
(43) Pub. Date: Oct. 25, 2018

(54) ACTIVATOR HAVING A LOW PH VALUE FOR SUPPLEMENTARY CEMENTITIOUS MATERIAL

(71) Applicant: HeidelbergCement AG, Heidelberg (DE)

(72) Inventors: Mohsen BEN HAHA, Heidelberg (DE); Tim LINK, Luenen (DE); Frank BELLMANN, Weimar (DE); Horst-Michael LUDWIG, Weimar (DE)

(73) Assignee: HeidelbergCement AG, Heidelberg (DE)

(21) Appl. No.: 15/580,049

(22) PCT Filed: Jun. 14, 2016
(86) PCT No.: PCT/EP2016/000984

§ 371 Date: Dec. 6, 2017

(30) Foreign Application Priority Data
Jun. 16, 2015 (EP) 15001773.9

(51) Int. Cl. C04B 7/345; C04B 7/43; C04B 28/02; C04B 28/08; C04B 28/04

(52) U.S. Cl. CPC C04B 7/3453; C04B 7/43; C04B 2103/10; C04B 28/08; C04B 28/04; C04B 28/025

(57) ABSTRACT

Activators for supplementary cementitious material, comprising reactive belite, obtainable by hydrothermal treatment of a starting material, which contains sources for CaO and SiO2 in an autoclave at a temperature of 100 to 300° C. and tempering the obtained intermediate product at 350 to 495° C., hydraulic binders based on the supplementary cementitious material above, and by a method for activating the supplementary cementitious material by adding reactive belite obtainable by hydrothermal treatment of a starting material which contains sources for CaO and SiO₂ in an autoclave at a temperature of 100 to 300° C. and tempering the obtained intermediate product at 350 to 495° C. and the use of the reactive belite containing material as activator.

The present invention relates to activators for supplementary cementitious material, i.e. latent-hydraulic and/or puzzolanic materials, hydraulic binding agents based on latent-hydraulic and/or puzzolanic materials, such as granulated slag and/or tempered clays/shale, fly ash, and a method for activating latent-hydraulic and/or pozzolanic materials.

Granulated blast furnace slag is vitreously solidified, granulated blast furnace slag. Blast furnace slag emerges in the blast furnace during pig iron production as a result of the components rich in Al₂O₃ and SiO₂ of the non-metallic ore concomitant phases and the coke ash connecting to the chalk aggregate to form chalk aluminate silicates during the melting process. It thus performs important metallurgical tasks. It frees the pig iron from the sulphur of the coke, the furnace from alkalis and protects the pig iron from reoxidation. The blast furnace slag floats on the iron because of its lower density. By optimising its composition, the melting point is minimised and, as a result of its low viscosity, the easy separability from the fluid iron is ensured. If the melted blast furnace slag is slowly cooled down in the air, it crystallises almost completely and a particulate, hard, hydraulically inactive material emerges. This material referred to as blast furnace lump slag acts practically inertly in the finely ground state towards water. It is used in road construction, for example, as a result of this property and its hardness.

Since 1862, it has been known that by quenching the melted blast furnace slag with water, a sandy, vitreous granulate can be produced that has latent-hydraulic properties. In this “granulation”, the molten mass is cooled down very quickly from approx. 1500° C. to below the so-called transformation temperature of 840° C. and divided by means of up to a tenfold excess of water. For such “granulated” blast furnace slag, from the start of the 20th century onwards, the term “ground granulated blast furnace slag” has been increasingly used and, in 1954, was categorised as a denotation by the Verein Deutscher Eisenhüttenleute (Steel Institute VDEh).

Hydraulic binding agents in a finely ground state can cure both in air and underwater after mixing with water. Materials that show this curing in a pure state, e.g. Portland cement clinker are referred to as hydraulic. Materials are then referred to as latent-hydraulic, when they are able to cure hydraulically in principle, but to do so require one or more activators, such as ground granulated blast furnace slag and artificial glasses (with a chemical composition that is comparable to ground granulated blast furnace slag), for example. The characterisation “latent-hydraulic” is used in order to describe the particular properties of ground granulated blast furnace slags and binding agents comparable to them. It describes that a certain binding agent is similar to the Portland cement both in terms of its ability to cure hydraulically and in its chemical composition. A latent-hydraulic binding agent accordingly contains both reactive SiO₂ and reactive CaO in sufficiently high quantities in order to hydraulically cure by means of an external impetus (activator) with water, by forming calcium silicate hydrates.

In contrast, pozzolans or pozzolanic materials are natural or industrially manufactured substances, such as tempered clays and shale, trass, brick dust, low-calcium (e.g. according to DIN EN 450-1 [V] but also sometimes calcium-rich (>10% by weight CaO, e.g. DIN EN 197-1) [W] fly ash that can contain only reactive SiO₂ or also Al₂O₃ and/or Fe₂O₃ as well, but cannot harden independently with water. In principle, with exceptions, such as W fly ash, for example, puzzolans do not contain CaO or contain only very little. Therefore, in contrast to the latent-hydraulic binding agents, they obligatorily need an addition of CaO or Ca(OH)₂ for a hydraulic hardening based on the formation of calcium silicate hydrates.

Calcium-rich fly ash, trass, brick dust and tempered clays and shale can have latent-hydraulic or pozzolanic properties, depending on chemical and mineralogical composition, above all with regards to their content and the distribution of the reactive CaO, SiO₂ and Al₂O₃ (reactive phase, glass content, etc.).

Fly ash is obtained from the flue gases of combustion power plants by means of the electrostatic or mechanical deposition of dust-like particles. Typically, fly ash particles are present predominantly in the shape of spherical glass.

From data supplied by the FEhS Institute for Building Materials—Forschung e.V. in 2006, 142 European granulated slags tested between 1995 and 2006 were composed, on average as shown in Table 1 (content of the main components in % calculated in an ignition loss-free manner):

TABLE 1

| | Average | Min. | Max. |
|---|---|---|---|
| CaO | 39.4 | 30.7 | 45.6 |
| MgO | 8.8 | 3.5 | 17.3 |
| SiO₂ | 36.8 | 30.7 | 44.0 |
| Al₂O₃ | 11.2 | 5.4 | 16.4 |
| FeO | 0.6 | 0.1 | 2.2 |

The average glass content of these granulated slags was 95%.

Over time, considerable research has led to identification and use of certain substance groups as activators of the latent-hydraulic properties of ground granulated blast furnace slags. In principle, in terms of the hydraulic activity of ground granulated blast furnace slags, at the moment, the following statements are accepted to be correct:
An increase of the basicity CaO/SiO₂ (C/S—ratio) leads to an increase in reactivity.
The hydraulic hardening capability increases with an increasing content of CaO and MgO.
Higher amounts of aluminia increase the early strength under the following conditions:
   This statement applies to the vitreous portion of the granulated slag;
   The binding agents contain sulphate carriers for binding the aluminium by forming ettringite.

In general, today we talk of two fundamental types of activation: alkaline and sulphatic activation. The activating effect of the basic calcium hydrate on the latent-hydraulic and/or pozzolanic materials, here illustrated by means of the example of ground granulated blast furnace slag, was known previously and as early as 1865 it was used commercially for producing slag stones. Portland cements containing ground granulated blast furnace slag were first produced in 1879 and, thus, the activating effect of calcium hydroxide emerging during the hydration of calcium silicates together with the alkali hydroxides present in Portland cement was used. The calcium hydroxide released by Portland cement here acts as an activator of the latent-hydraulic properties of the granulated slag and, in contrast to its role in pozzolans, does not exclusively have the task of forming new quantities of calcium silicate hydrates that are relevant to strength.

The latent-hydraulic properties of ground granulated blast furnace slags have led to them being used in steadily increasing quantities as a component of cements for decades. According to EN 197-1, in the Portland slag cements CEM II/A-S and CEM II/B-S, ground granulated blast furnance slag between 6 and 35% can be contained and, in the blast furnace cements CEM III/A and CEM III/B between 36 and 80%, and can replace corresponding amounts of clinker. Since the CaO-content of ground granulated blast furnace slags is approx. 40% on average and thus amounts to only roughly ⅔ of the average CaO content of Portland cement CEM I, the production of cements that contain ground granulated blast furnace slag is, in principle, associated with a reduction of CO₂ emissions, which is in direct proportion to their ground granulated blast furnace slag content.

Also in terms of its durability and resistance to aggressive, e.g. to sulphate-containing or slightly acidic waters, an increasing in latent-hydraulic and/or pozzolanic materials in Portland cement is advantageous.

An essential, limiting criterion for the usage amount of latent-hydraulic and/or puzzolanic materials in cement, however, is the fact that an increasing replacement of finely ground Portland cement clinker with ground granulated blast furnace slag, for example, of comparable fineness in the first few days after mixing with water leads to systematically decreasing compressive strengths in mortar and concrete. While in the past this phenomenon was interpreted as “lower reactivity”, the concept of reactivity is seen today increasingly more differentiated. It has been shown that ground granulated blast furnace slags classified as “less reactive” in terms of their ability to react with water, i.e. those that are more resistant to corrosion, in mixtures with Portland cements, regularly lead to higher early strengths than the same mixtures with “reactive” ground granulated blast furnace slags. In light of this, attempts are increasingly made to prevent the formation of unfavourable reaction products that lead to lower compressive strengths in “reactive” ground granulated blast furnace slags by using suitable additives.

In contrast to alkaline activation, which is mainly effective with Portland cements containing ground granulated blast furnace slag, the sulphatic activation discovered by H. Kühl, in the first step, is based on the formation of ettringite, i.e. a direct chemical reaction between the Al₂O₃ content of the ground granulated blast furnace slags, low quantities of added calcium hydroxide and 15 to 20% added calcium sulphate.

Also in the field of so-called super sulphated cements, recently there has again been considerable activity by different building material manufacturers with the aim to overcome the known disadvantages of this binding agent system. In the 1970s, the decreasing early strengths as a result of the progressive reduction of the Al₂O₃ content of ground granulated blast furnace slags eventually led to the withdrawal of the DIN 4210 standard that had existed since 1937.

One disadvantage of the known activators is the high pH value of the binder mixed with water. Thus, a saturated calcium hydroxide solution has a pH value of 12.6. High pH values, on the one hand, are unwanted in terms of occupational safety because they entail additional effort and thus costs. On the other hand, there are applications in which other materials that come into contact with the binder are sensitive to high pH values, for example embedded glass fibres. Thus, there is the need for activators and binders that enable a reliable and rapid hardening with low pH values.

One suggestion for this can be found in WO 2012/055517 A1 which describes that the weakly alkaline magnesium hydroxide carbonate that is virtually insoluble in water is suitable to react practically completely when added to the ground granulated blast furnace slag of the grinding fineness common in cement, with the granulated slag after mixing with water to form a paste or a mortar, within a short period of time and thus to cause a hardening process.

A further suggestion is the use of ternesite, C₅S₂$, which is described in EP 2 617 691 A1.

An activation with chalk takes placed in chalk slag composite binders, see Micheline Moranville Regourd, Cements made from blast furnace slag in Leas Chemistry of cement and concrete, 2001, page 647, for example. Chalk slag composite binders “lime slag cements” arise by mixing ground granulated blast furnace slag rich in chalk with 10-30% chalk or hydraulic chalk. Here, the slow hardening in comparison to Portland cement and the ageing or deterioration in quality during storage (since the chalk contained can carbonate) are disadvantageous. The slow strength development can be counteracted by adding sodium sulphate or gypsum. However, sodium sulphate can lead to efflorescences.

The object of the invention was to create a further activation mechanism that is able to initiate in latent-hydraulic and/or pozzolanic materials, such as finely ground granulated blast furnace slags, industrial and natural (fly) ashes, artificial glasses and tempered clays and shale, a strength developing reaction within a few hours after mixing with water, also without using the known, highly alkaline or sulphatic activation (by means of anhydrite, basanite and/or gypsum).

Surprisingly, it was now found that a belite produced by hydrothermal treatment and tempering is able to activate the hydraulic reaction of latent-hydraulic and/or pozzolanic materials.

The invention thus solves the above object by means of an activator for supplementary cementitious material, comprising reactive belite, obtainable by hydrothermal treatment of a starting material, which contains sources for CaO and SiO₂, in an autoclave at a temperature of 100 to 300° C. and tempering the obtained intermediate product at 350 to 495° C. The object is further solved by hydraulic binder based on supplementary cementitious material and reactive belite as the activator, obtainable by hydrothermal treatment of a starting material which contains sources for CaO and SiO₂, in an autoclave at a temperature of 100 to 300° C. and tempering the obtained intermediate product at 350 to 495° C., as well as a method for activating supplementary cementitious material by adding reactive belite, which is obtainable by hydrothermal treatment of a starting material which contains sources for CaO and SiO₂, in an autoclave at a temperature of 100 to 300° C. and tempering the obtained intermediate product at 350 to 495° C. Finally, the object is solved by using belite that contains sources for CaO and SiO₂, in an autoclave at a temperature of 100 to 300° C. and tempering the obtained intermediate product at 350 to 495° C. as the activator for supplementary cementitious material in hydraulic binders.

The following abbreviations that are common in the cement industry are used: H—H₂O, C—CaO, A—Al₂O₃, F—Fe₂O₃, M—MgO, S—SiO₂ and $—SO₃. In order to simply the further description, generally, compounds are stated in their pure form, without explicitly stating mixing series/substitution by foreign ions etc., as are common in technical and industrial materials. As is understood by every person skilled in the art, the composition of the phases nominally stated in this invention can vary depending on the chemism of the raw meal and the kind of production as a result of the substitution with diverse foreign ions, wherein such compounds also fall under the scope of protection of the present invention and shall be comprised by stating the pure phases/compounds.

Reactive belite, which is obtainable by hydrothermal treatment and subsequent tempering, is known as such. Thus, EP 2 676 943 A1 describes a method for producing belite cement having high reactivity, in which a starting material made of raw materials is provided, which has a molar Ca/Si ratio of 1.5 to 2.5, the starting material is treated hydrothermally in the autoclave at a temperature of 100 to 300° C. and a residence time of 0.1 to 24 h, wherein the water/solid ratio is 0.1 to 100, thereby the obtained intermediate product is tempered at 350 to 495° C., wherein the heating rate is 10-6000° C./min and the residence time is 0.01-600 min, and wherein, when mixing and/or in the following steps, 0.1 to 30% by weight of additional elements and/oxides are added.

Further methods for producing reactive belite can be found in the documents mentioned in this document as prior art.

From EP 2 801 558 A1, the use of a belite calcium aluminate as an accelerator for Portland cement is also known, which is obtained in a method that comprises the following steps: Providing a starting material that has a molar Ca/(Si+Al+Fe) ratio of 1.0 to 3.5 and a molar Al/Si ratio of 100 to 0.1, mixing the raw materials, hydrothermally treating the starting material in the autoclave at a temperature of 100 to 300° C. and a residence time of 0.1 to 24 h, wherein the water/solid ratio is 0.1 to 100, tempering the obtained intermediate product at 350 to 600° C., wherein the heating rate is 10-6000° C./min and the residence time is 0.01-600 min.

A usefulness of reactive belite as an activator for supplementary cementitious material, i.e. latent-hydraulic and/or pozzolanic materials, such as ground granulated blast furnace slag or metakaolin, for example, or a strength formation of binders made of reactive belite and latent-hydraulic and/or pozzolanic materials cannot be found in these documents. It was thus very surprising that belite obtained by means of hydrothermal treatment and tempering in combination with latent-hydraulic and/or pozzolanic materials provides a sufficient to even high early strength.

Reactive belite can be produced by means of hydrothermal treatment of a starting material made of one or more raw materials, which provide sufficient amounts of CaO and SiO₂. Here, on the one hand, pure or substantially pure raw materials, such as calcium carbonate or oxide and quartz powder or microsilica, are suitable. On the other hand, a multitude of natural but also industrial materials, such as, but not exclusively, limestone, bauxite, clay/claystone, calcined clays (e.g. metakaolin), basalts, periodites, dunites, ignimbrites, carbonatites, ashes/slags/ground granulated blast furnace slags of high and low quality (mineralogy/glass content, reactivity, etc.), diverse stockpile materials, red and brown muds, natural sulphate carriers, desulphurisation slurry, phosphogypsum, flue gas gypsum, titanium gypsum, fluorogypsum, etc., for example, are used in a suitable combination as the starting material. Substances/substance groups which fulfil the minimum chemical requirements as potential raw materials that are not nominally stated are also inside the scope.

Particularly preferred are raw materials that contain both SiO₂ and CaO, such that the desired ratio of Ca/Si is already present. If the desired Ca/Si ratio is not already present, then the raw materials have to be adjusted in terms of the chemical composition before further treatment by adding further reaction partners such as solids containing Ca or Si to a suitable Ca:Si ratio in the starting material that is generally from 1.5 to 2.5. To do so, for example Portlandite Ca(OH)₂ or calcinated or non-calcinated chalk are suitable. Generally, the raw materials or the starting material are optimised in terms of particle size and particle size distribution by means of mechanical or thermal treatment, wherein the thermal treatment can also lead to an optimisation of the chemical composition.

The preferred secondary raw materials also introduce further elements, such as aluminium, iron, magnesium and others into the starting material, in addition to sources for CaO and SiO₂. These further elements are introduced into the phases as foreign ions or form individual phases. If they are present, a molar (Ca+Mg)/(Si+Al+Fe) ratio of 1 to 3.5, a molar ratio of Ca:Mg of 0.1 to 100 and a molar ratio (Al+Fe)/Si of 100 to 0.1 is preferred. The molar ratio of the sum of calcium and magnesium to the sum of silicon, aluminium and iron shall preferably be 1.5 to 2.5, particularly preferably about 2. The ratio of calcium to magnesium is preferably 0.2 to 20, particularly preferred from 0.5 to 5. The ratio of the sum of aluminium and iron to silicon is preferably 100 to 10 for a high aluminium content, 1 to 20 for an average aluminium content and 0.01 to 2 for a low aluminium content.

In a preferred embodiment, fine grain material is chosen as the starting material, the largest grain of which being preferably no more than 0.1 mm. To do so, in particular the finer grain fractions from the reprocessing of binders containing cement in building materials such as old concretes and old cements are used. A finer starting material is also advantageous in terms of the conversion speed.

The starting material or the raw materials can be burnt in an additional step. This step is particularly preferred when using industrial by-products or relatively low reactive or coarse materials as the raw materials. Here, temperatures of 400 to 1400° C., preferably of 750 to 1100° C., are suitable. The burning time is 0.1 to 6 hours, preferably about 1 hour. By burning the starting material/the raw materials the advantage results that substances can be made usable in a targeted manner, which otherwise cannot or can hardly be used (e.g. crystalline ashes and slags etc.) by an improved/greater convertability in the autoclave being made possible to form the intermediate product α-C₂SH (by deacidification and or dewatering). Furthermore, it offers the advantage that precursor phases (e.g. unreactive belite) can be produced in a targeted manner which have products having particularly high contents of x-C₂S, α-C₂S and/or at least one reactive, X-ray amorphous phase after hydrothermal treatment and tempering. The advantage of the use of belite as the raw material for the autoclave process is an improved phase composition of the final product in comparison to unburnt raw materials.

It is advantageous to add additional elements or oxides in an amount of 0.1 to 30% by weight to the starting material, e.g. when mixing the raw materials, or in one of the subsequent process steps. Sodium, potassium, boron, sulphur, phosphorous or combinations thereof are preferred as these additional elements/oxides which are also collectively referred to as foreign ions. For this, alkaline or earth alkaline metal salts and/or hydroxides, for example CaSO₄.H₂O, CaSO₄.½ H₂O, CaSO₄, CaHPO₂.2H₂O, Ca₃P₂O₈, NaOH, KOH, Na₂CO₃, NaHCO₃, K₂CO₃, MgCO₃, MgSO₄, Na₂Al₂O₄, Na₃PO₄, K₃PO₄, Na₂[B₄O₅(OH)₄]. 8H₂O etc. are suitable. In a preferred embodiment, the starting material has a molar ratio of P/Si of about 0.05 and/or S/Si of about 0.05 and/or Ca/K of about 0.05.

The starting material, optionally pre-treated as described, can advantageously be mixed, i.e. seeded, with seed crystals, which contain calcium silicate hydrates, Portland clinkers, ground granulated blast furnace slag, magnesium silicates, calcium sulphate aluminate (belite) cement, water glass, glass powder etc., for example. Herein, the reaction can be accelerated by seeding with 0.01-30% by weight different compounds containing calcium silicate hydrate, in particular with α-2CaO.SiO₂.H₂O, afwillite, calcio-chondrodite, β-Ca₂SiO₄ and other compounds.

The starting material, which is optionally pretreated and/or seeded as described above, is then subjected to a hydrothermal treatment in the autoclave at a temperature of 100 to 300° C., preferably from 150 to 250° C. Herein, a water/solid ratio of 0.1 to 100, preferably of 2 to 20, is preferably chosen. The residence times are typically from 0.1 to 24 hours, preferably from 1 to 16 hours, in particular from 2 to 8 hours. By means of the hydrothermal treatment, the starting material is converted into an intermediate product containing at least one calcium silicate hydrate and optionally further compounds.

In an embodiment, the intermediate product can be ground, wherein the grinding process can take place on both a wet and on a dried intermediate product. The object of the grinding is a deagglomeration and an improvement of the grain size range. Both the intermediate product and mixtures with the supplementary cementitious material to be activated or parts thereof can be ground. Surprisingly, it was found that grinding the intermediate product leads to significantly more reactive end products. However, reaction grinding does not take place, i.e. the grinding energy supplied is limited in such a way that substantially no chemical conversions are triggered.

The optionally ground intermediary product is tempered at a temperature of 350° C. to 495° C., preferably at more than 400° C. Herein, the heating rate is 10-6000° C./min, preferably 20-100° C./min, and particularly preferred about 40° C./min. A residence time of 0.01 to 600 min, preferably 1-120 min and particularly preferred 5-60 min is suitable.

To decrease the proportion of unreactive γ-C₂S, an additional holding time during heating up at 400-440° C. of 1-120 min, preferably of 10-60 min, has proved successful.

It also turned out that a removal of the water formed during tempering is beneficial for the reactivity. Thus, the water formed is preferably removed during tempering, for example by means of a continuous gas flow or by means of negative pressure or by means of a high surface/volume ratio of the intermediate product. A continuous gas flow, in particular air flow, is particularly preferred.

After cooling down, an end product is obtained which contains the desired, reactive belite. The end product contains 30-100% of the following compounds: x-Ca₂SiO₄, X-ray amorphous compounds of a variable composition, β-Ca₂SiO₄ and reactive γ-Ca₂SiO₄ having a phase specific degree of hydration usually of at least 50% in the first 7 days after mixing with water.

The BET surface of the end product can be 1 to 30 m²/g. The SiO₂ tetrahedrons in the end product have an average degree of condensation of less than 1.0. The water content in the binding agent is less than 3.0% by weight.

The end product is optionally ground to a desired fineness or grain distribution in a manner known as such. The grinding can also take place together with the supplementary cementitious material or parts thereof. Common grinding aids, such as alkanolamines, ethylenglycoles and propylenglycoles can be used. With fine raw materials and suitable grain distribution, grinding can be superfluous. If the intermediate product or mixtures of the intermediate product and the supplementary cementitious material to be activated have already been ground, a further grinding process of the tempered product can mostly be dispensed with.

The end product preferably contains x-Ca₂SiO₄ in an amount of >30% by weight and at least one X-ray amorphous phase in an amount of >5% by weight, wherein all proportions of the end product add up to 100%.

Highly reactive belite can be produced by means of the method, which is suitable as the activator for supplementary cementitious material. Very reactive polymorphs and X-ray amorphous phases are contained. Furthermore, γ-Ca₂SiO₄ is also contained. The formation of this polymorph is avoided when producing Portland cement by means of a quick clinker cooling, since this polymorph does not contribute to the strength development. In contrast to the production of this phase by sintering, during production by means of hydrothermal treatment and tempering at <500° C., it shows a good reactivity. Materials produced in such a way have a pH value below 12.6 in aqueous surroundings, wherein the pH value of below 12 directly after mixing with water increases up to about 12.5 after 30 to 60 minutes.

For the present invention, clinker means a sinter product, which is obtained by burning a raw material mixture at an increased temperature and which contains at least one hydraulically reactive phase. Cement denotes a clinker ground with or without the addition of further components as well as a similarly fine-grained material obtained in a different manner, which reacts hydraulically with water after mixing. Binder or binder mixture refers to a hydraulically hardening mixture containing cement and typically, but not necessarily, other finely ground components, said mixture being used after the addition of water, optionally additives and aggregate. Unless stated otherwise, “reactive” means a hydraulic reactivity.

In the binder according to the invention, at least one supplementary cementitious material, i.e. a latent-hydraulic and/or pozzolanic material, is mixed with reactive belite, obtainable as described, as the activator. The quantities are very variable, preferably 5 to 95% by weight of latent-hydraulic and/or pozzolanic material and 5 to 95% by weight of activator are used. 30 to 85% by weight of latent-hydraulic and/or pozzolanic material and 15 to 70% by weight of activator are preferred, particularly preferred are 40 to 80% by weight of latent-hydraulic material and 20 to 60% of activator, wherein the values are based on the total amount of binder and the proportions add up to 100% with the rest of the binder components.

Preferred pozzolans/latent-hydraulic materials are tempered clays (e.g. metakaolin) and shale, V and W fly ashes having high glass content and/or amount of reactive phases, ground granulated blast furnace slags and artificial (pozzolanic and latent-hydraulic) glasses.

Preferably, the binder also contains admixtures and/or additives, as well as optionally further hydraulically active components and/or sulphate carriers.

The additives are hydraulically non-active components, such as, but not exclusively, ground limestone/dolomite, precipitated CaCO₃, Mg(OH)₂, Ca(OH)₂, CaO, silica fumes and glass flour, for example. In total, the additives can be dosed in an amount ranging from 1 to 25% by weight, preferably from 3 to 20% by weight and yet more preferably from 6 to 15% by weight.

As the sulphate, in particular alkaline and/or earth alkaline metal sulphates, preferably in the form of gypsum and/or hemihydrate and/or anhydrite and/or magnesium sulphate and/or sodium sulphate and/or potassium sulphate are suitable.

In a preferred embodiment, the binder contains at least one additional hydraulic material, preferably Portland cement. Here, the Portland cement can be both quantitatively predominant analogously to the Portland slag cements, and also, analogously to the blast furnace and composite cements, contain comparable amounts of Portland clinker and mixtures of latent-hydraulic material with activator up to predominantly mixtures of latent-hydraulic material with activator. Preferably, the binder can contain from 1 to 70% by weight, in particular from 5 to 40% by weight and particularly preferred from 10 to 25% by weight, of Portland cement.

The activator, the latent-hydraulic and/pozzolanic material, and optionally present additives, such as limestone and/or Portland cement clinker and/or other clinkers and/or sulphate carriers, for example, are ground in the binder according to the invention to a fineness (according to Blaine) of 2000 to 10000 cm²/g, preferably from 3000 to 6000 cm²/g and particularly preferred from 4000 to 5000 cm²/g. The grinding can take place separately or together in a manner known as such.

Preferably, the cement or the binding agent mixture also contains one or more setting and/or curing accelerators as the admixture, preferably selected from components having available aluminium or those that release aluminium on contact with water, for example in the form of Al(OH)₄⁻ or amorphous Al(OH)₃ gel, such as, but not exclusively, soluble alkaline/earth alkaline metal salts (e.g. Na₂Al₂O₄, K₂Al₂O₄, aluminium nitrate, acetate, chloride, formate, sulphate etc.), reactive and/or amorphous aluminium hydroxide (e.g. Al(OH)₃), calcium aluminate cement, calcium sulphoaluminate cement and/or geopolymer binders. Furthermore, the cement or the binder mixture can contain one or more setting and/or curing accelerators as admixture, also in combination with the components mentioned above having available aluminium, preferably selected from lithium salts and hydroxides, other alkaline salts and hydroxides, alkaline silicates. In total, the setting and/or curing accelerators can be dosed in an amount ranging from 0.01 to 15% by weight, preferably from 0.5 to 8% by weight and yet more preferred from 1 to 5% by weight.

Curing accelerating additions, such as alkaline/earth alkaline metal aluminates, aluminium salts, alkaline salts, alkaline silicates and alkaline hydroxides, for example, which increase the pH value of the solution, are particularly preferred.

It is further preferred when concrete water reducing agents and/or plasticizers and/or retarders, preferably based on lignin sulphonates, sulphonised naphthalene, melamine or phenol formaldehyde condensate, or based on acrylic acid acrylamide mixtures or polycarboxylate ethers or based on phosphated polycondensates, phosphated alkyl carboxylic acid and salts thereof, (hydroxy)carboxylic acids and carboxylates, borax, boric acid and borates, oxalates, sulphanilic acid, amino carboxylic acids, salicylic acid and acetyl salicylic acid, dialdehyde, are contained.

Furthermore, air entraining agents, water repellents, sealants, and/or stabilisers can be contained. The dosing of the admixtures takes place in the usual amounts.

The binders according to the invention can be used in a manner known as such for all applications in which Portland cement, Portland slag cement, composite cement etc. are otherwise used. Generally, the binder is mixed for use with aggregates and optionally further additions, to form e.g. concrete, mortar, plaster, screed stc. and mixed with water.

When processing the binder according to the invention, a water/binder ratio of 0.2 to 2 is suitable, preferably from 0.3 to 0.8 and particularly preferred from 0.35 to 0.5.

The cement according to the invention or the binder according to the invention is very well suited for solidifying hazardous waste. To do so, a content of adsorptively effective additives, e.g. zeolites and/or ion exchange resins, is preferred. When immobilising heavy metals in inorganic binders, a high pH value can be advantageous, which facilitates the formation of hardly soluble hydroxides. This can, for example, but not exclusively, be implemented by mixing the binding agent according to the invention with Portland cement and/or alkaline salts and hydroxides.

The invention shall be explained by means of the following examples, though without being limited to the specifically described embodiments. Unless otherwise stated or unless anything different compellingly emerges from the context, the percentages relate to the weight, in case of doubt to the total weight of the mixture.

The invention also covers all combinations of preferred embodiments, as long as these are not mutually exclusive. The statements “about” or “approx.” in connection with a number mean that values at least 10% higher or lower or values 5% higher or lower and in any case values 1% higher or lower are included.

### EXAMPLES

In table 2, the ground granulated blast furnace slag (HÜS) used, with which the examples described below have been carried out, is characterised by means of its oxidic main components. The weight loss after tempering at 1000 C is also stated. The grinding fineness is 5750 cm²/g according to Blaine.

TABLE 2

| Component | Content [%] |
|---|---|
| LOI 1000° C. | 0.5 |
| SiO₂ | 35.4 |
| Al₂O₃ | 12.6 |
| TiO₂ | 1.18 |
| MnO | 0.28 |
| Fe₂O₃ | 0.4 |
| CaO | 42.9 |
| MgO | 4.8 |
| K₂O | 0.36 |
| Na₂O | 0.24 |
| SO₃ | 0.2 |
| P₂O₅ | 0.04 |
| S | 1.35 |
| Total | 100.15 |

### Example 1

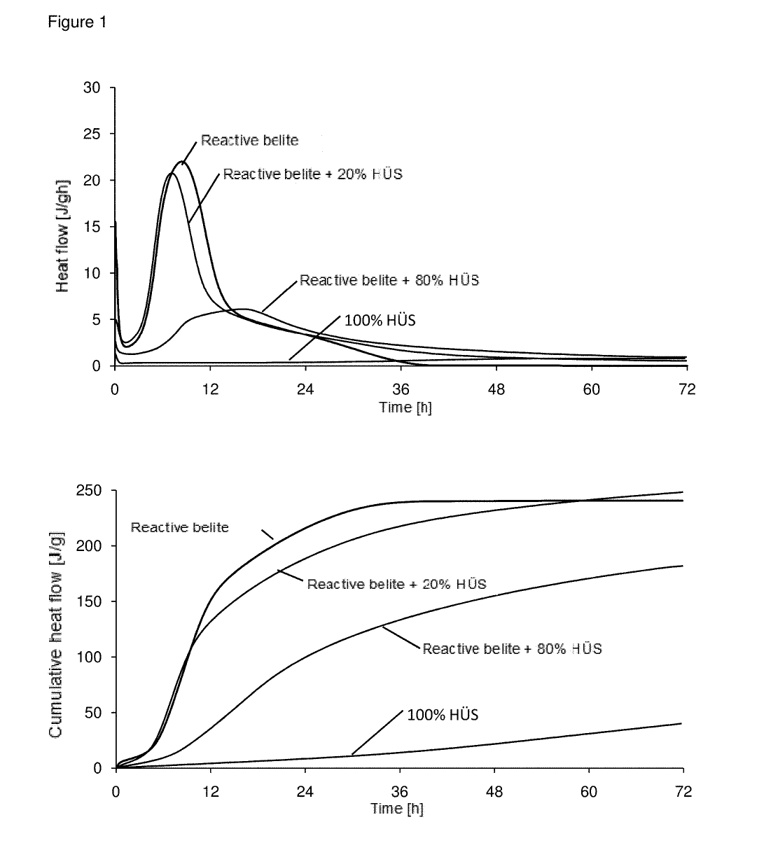

Firstly, an intermediate product is synthesised as follows for the production of the reactive belite as the activator. Producing a mixture of Ca(OH)₂ and nano-SiO₂ in a molar ratio of 2:1. After adding seed crystals from 5% by weight α-2CaO.SiO₂.H₂O, the mixture was homogenised with water. The ratio of water/solid was 2. An autoclave treatment at 15 bar for 16 h followed. Subsequently, drying at 60° C. took place. The intermediate product was composed of 97% by weight of α-2CaO.SiO₂.H₂O and 3% by weight of amorphous components. By subsequently tempering at 420° C., the intermediate product was transformed into the activator containing reactive belite. The activator consisted of 50% by weight of X-ray amorphous material, 40% by weight of x-Ca₂SiO₄, 5% by weight of γ-Ca₂SiO₄ and 3% by weight of α-2CaO.SiO₂.H₂O and 2% by weight of calcite. The activator produced in such a way was then mixed with 20 and 80% by weight of ground granulated blast furnace slag and homogenised in a tumble mixer. The two mixtures and the pure ground granulated blast furnace slag and the pure activator comprising reactive belite were tested by means of heat flow calorimetry for hydraulic reactivity. FIG. 1 shows the heat flow rates measured and the cumulative heat release. Table 3 compares the expected amounts of heat, which were calculated from the proportions of the pure components, with the amounts of heat measured of the mixtures.

TABLE 3

| Activator | | Granulated slag | | Total reaction heat after 3 | |
|---|---|---|---|---|---|
| | Total heat | | Total heat | days | |
| Proportion | contribution* | Proportion | contribution* | Calculated sum* | Measurement |
| [Mass %] | [J/g] | [Mass %] | [J/g] | [J/g] | [J/g] |
| 100 | 246 | 0 | 0 | 246 | 246 |
| 80 | 197 | 20 | 6 | 203 | 248 |
| 20 | 49 | 80 | 32 | 81 | 183 |
| 0 | 0 | 100 | 40 | 40 | 40 |

*calculated for the mixtures from the proportion of the component.

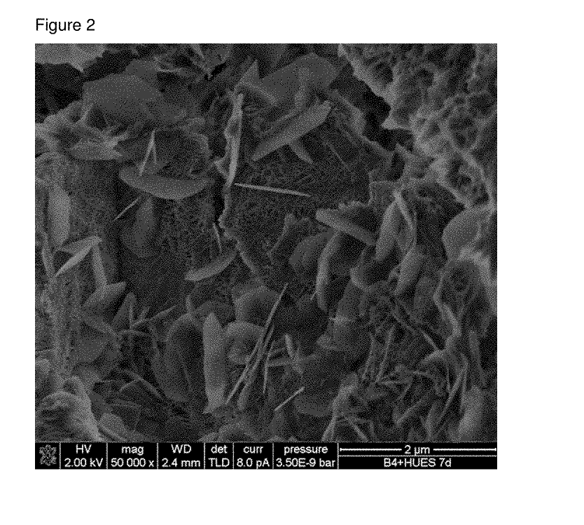

The comparison shows that the amounts of heat measured are clearly higher than those calculated from the components. The difference can be traced back to an activation of the granulated slag. The hydration products of the mixture of activator containing reactive belite and 20% by weight of granulated slag were also tested by means of scanning electron microscopy. FIG. 2 shows that hydration products of the ground granulated blast furnace slag were formed.

### Example 2

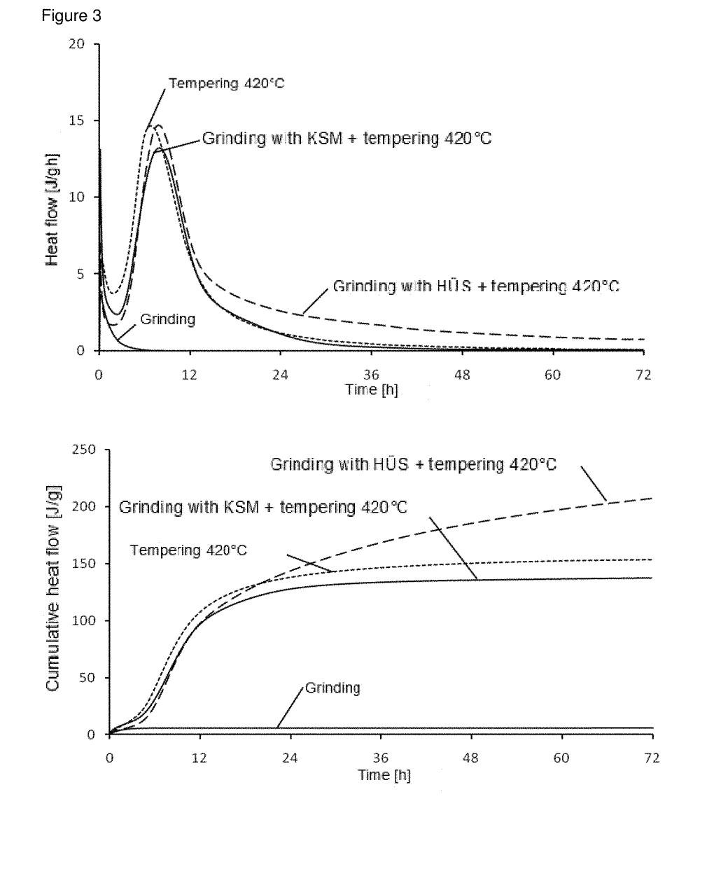

A mixture of Ca(OH)₂ and highly dispersed SiO₂ was produced in a molar ratio of 2:1. After the addition of seed crystals from 5% by weight of α-2CaO.SiO₂.H₂O, the mixture was homogenised with water. The ratio of water/solid was 10. An autoclave treatment followed with constant stirring at 200° C. for 16 h. Subsequently, a drying at 60° C. took place. The intermediate product contained 87% by weight of α-2CaO.SiO₂.H₂O, 2% by weight of calcite, 2% by weight of scawtite and 9% by weight of amorphous components. The dried intermediate product was mixed with 40% by weight of ground granulated blast furnace slag and ground in a planetary ball mill for 3 min. Subsequently, a tempering at 420° C. took place. The measuring of the heat development by means of heat flow calorimetry is depicted in FIG. 3. The binder was tested in terms of compressive strength development. The water/binder ratio (w/b) was set to 0.3 by plasticizers. The strength was checked on cubes with an edge length of 4 cm. Strengths of 62 N/mm² emerged after 2 days, 77 N/mm² after 7 days and 85 N/mm² after 28 days.

### Example 3

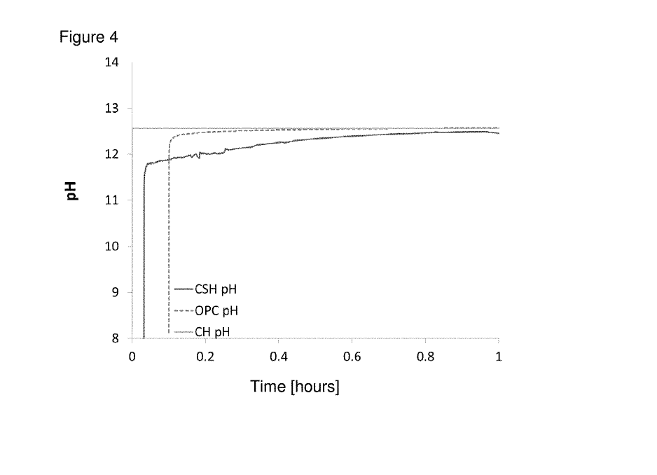

The pH value of calcium hydroxide, OPC and activator according to the invention was measured after mixing with water. The results are depicted in FIG. 4. Calcium hydroxide, light grey curve CH, had a pH value of 12.6 practically immediately after mixing. Portland cement, dotted curve OPC, also quickly obtained a pH value above 12. The activator according to the invention, black curve CSH, in comparison to OPC, shows a quicker solution, wherein the pH value, though, remained below 12.5 for more than 30 minutes and was also still below 12.6 after 1 hour. Thus, the activator according to the invention has a lower pH value than OPC or calcium hydroxide and a much lower pH value than sodium or potassium hydroxide.

1-19. (canceled)

20. An activator for supplementary cementitious material that comprises reactive belite, containing x-Ca₂SiO₄ in an amount of >30% by weight and at least one X-ray amorphous phase in an amount of >5% by weight, and is obtainable by hydrothermal treatment of a starting material, which contains sources for CaO and SiO₂, in an autoclave at a temperature of 100 to 300° C. and a residence time of 0.1 to 24 hours, and tempering the obtained intermediate product at 350 to 495° C. and a residence time of 0.01 to 600 min.

21. A hydraulic binder based on supplementary cementitious material and reactive belite, containing x-Ca₂SiO₄ in an amount of >30% by weight and at least one X-ray amorphous phase in an amount of >5% by weight, as an activator, wherein the activator is obtainable by hydrothermal treatment of a starting material, which contains sources for CaO and SiO₂, in an autoclave at a temperature of 100 to 300° C. and a residence time of 0.1 to 24 hours, and tempering the obtained intermediate product at 350 to 495° C. and a residence time of 0.01 to 600 min.

22. The binder according to claim 21, wherein it contains 5 to 95% by weight supplementary cementitious material and 5 to 95% by weight activator, preferably 30 to 85% by weight supplementary cementitious material and 15 to 70% by weight activator, particularly preferred 40 to 80% by weight cementitious and 20 to 60% by weight activator, wherein the values are based on the total amount of binder and the proportions add up to 100% with the rest of the binder components.

23. The binder according to claim 21, wherein the supplementary cementitious material is selected from tempered clays, such as metakaolin and shale; V and W fly ash having a high glass content and/or a content of reactive phases; ground granulated blast furnace slags; artificial (pozzolanic and latent-hydraulic) glasses and mixtures thereof.

24. The binder according to claim 21, further comprising admixtures and/or additives.

25. The binder according to claim 24, further comprising additives selected from hydraulically non-active components, such as ground limestone/dolomite, precipitated CaCO₃, Mg(OH)₂, Ca(OH)₂, CaO, silica fumes and glass flour.

26. The binder according to claim 24, wherein, in total, the binder contains additives in an amount ranging from 1 to 25% by weight, preferably from 3 to 20% by weight and yet more preferably from 6 to 15% by weight.

27. The binder according to claim 24, the admixtures are selected from setting accelerators, hardening accelerators, concrete water reducing agents, plasticizers, retarders and mixtures thereof.

28. The binder according to claim 21, further comprising at least one additional hydraulic material, preferably Portland cement.

29. The binder according to claim 28, wherein the additional hydraulic material is present in an amount of from 1 to 70% by weight, in particular from 5 to 40% by weight and particularly preferred from 10 to 25% by weight.

30. A method for activating latent-hydraulic and/or pozzolanic materials by adding reactive belite, containing x-Ca₂SiO₄ in an amount of >30% by weight and at least one X-ray amorphous phase in an amount of >5% by weight, that is obtainable by hydrothermal treatment of a starting material, which contains sources for CaO and SiO₂, in an autoclave at a temperature of 100 to 300° C. and a residence time of 0.1 to 24 hours, and tempering the obtained intermediate product at 350 to 495° C. and a residence time of 0.01 to 600 min to form a reactive belite containing activator.

31. The method according to claim 30, wherein the activator is ground together with the supplementary cementitious material.

32. The method for producing a binder according to claim 21, containing supplementary cementitious material and an activator, containing x-Ca₂SiO₄ in an amount of >30% by weight and at least one X-ray amorphous phase in an amount of >5% by weight, wherein the activator is obtained by hydrothermal treatment of a starting material, which includes sources for CaO and SiO₂, in an autoclave at a temperature of 100 to 300° C. and tempering the obtained intermediate product at 350 to 495° C., wherein the intermediate product is ground together with the supplementary cementitious material or a part thereof.

33. A building material, in particular concrete, mortar, plaster, screed or sealant, containing the binder according to claim 21, and at least one of aggregates, admixtures and additives.

34. Use of reactive belite, containing x-Ca₂SiO₄ in an amount of >30% by weight and at least one X-ray amorphous phase in an amount of >5% by weight, obtainable by hydrothermal treatment of a starting material, which contains sources for CaO and SiO₂, in an autoclave at a temperature of 100 to 300° C. and a residence time of 0.1 to 24 hours, and tempering the obtained intermediate product at 350 to 495° C. and a residence time of 0.01 to 600 min to form an activator containing reactive belite, as an activator of latent-hydraulic and/or pozzolanic supplementary cementitious material in hydraulic binders.

35. The use according to claim 34, wherein from 5 to 95% by weight supplementary cementitious material and 5 to 95% activator, preferably 30 to 85% by weight supplementary cementitious material and 15 to 70% by weight activator, particularly preferred 40 to 80% by weight supplementary cementitious material and 20 to 60% by weight activator, wherein the values are based on the total amount of binder and the proportions add up to 100% with the rest of the binder components.
